(19) United States
(12) Patent Application Publication
(10) Pub. No.: US 2016/0321522 A1
(43) Pub. Date: Nov. 3, 2016

(54) DEVICES, SYSTEMS, AND METHODS FOR PAIRWISE MULTI-TASK FEATURE LEARNING

(71) Applicant: CANON KABUSHIKI KAISHA, Tokyo (JP)

(72) Inventors: Jiangbo Yuan, San Jose, CA (US); Jie Yu, Santa Clara, CA (US)

(21) Appl. No.: 14/845,982

(22) Filed: Sep. 4, 2015

Related U.S. Application Data
(60) Provisional application No. 62/155,382, filed on Apr. 30, 2015.

(51) Int. Cl. G06K 9/66; G06N 3/08; G06N 3/04

(52) U.S. Cl. CPC G06K 9/66; G06N 3/04; G06N 3/08

(57) ABSTRACT

Systems, method, and devices for pairwise multi-task feature learning are described. The systems obtain a set of digital images, obtain a neural network, and select a pair of digital images, which includes a first image and a second image. Also, the systems forward propagate the first image through a first copy of the neural network, thereby generating a first output, and the systems forward propagate the second image through a second copy of the neural network, thereby generating a second output. Furthermore, the systems calculate a gradient of a joint loss function at a pairwise-constraint layer of the neural network based on the first output, on the second output, and on a target. Additionally, the systems modify the neural network based on the gradient.

### CROSS-REFERENCE TO RELATED APPLICATIONS

This application claims priority to U.S. Provisional Application No. 62/155,382, which was filed on Apr. 30, 2015 and is hereby incorporated by reference.

### BACKGROUND

1. Technical Field

This description generally relates to visual classification and retrieval.

2. Background

Various methods exist for extracting features from images. Examples of feature detection algorithms include scale-invariant feature transform (SIFT), difference of Gaussians, maximally stable extremal regions, histogram of oriented gradients, gradient location and orientation histogram, and smallest univalue segment assimilating nucleus. Also, images may be converted to representations. A representation is often more compact than an entire image, and comparing representations is often easier than comparing entire images. Representations can describe various image features, for example SIFT features, speeded up robust features (SURF features), local binary patterns (LBP) features, color histogram (GIST) features, and histogram of oriented gradients (HOG) features. Representations include, for example, Fisher vectors and bag-of-visual features (BOV).

### SUMMARY

In some embodiments, a method comprises obtaining a training set that includes digital images and side information of the digital images. The method also includes obtaining a joint loss function for two or more tasks. And the method includes learning new features based on the joint loss function and on the training set of digital images.

In some embodiments, a system comprises one or more computer-readable media and one or more processors that are coupled to the computer-readable media. The one or more processors are configured to cause the system to obtain a set of digital images, obtain a neural network, and select a pair of digital images, which includes a first image and a second image. Also, the one or more processors are configured to cause the system to forward propagate the first image through a first copy of the neural network, thereby generating a first output, and to forward propagate the second image through a second copy of the neural network, thereby generating a second output. Furthermore, the one or more processors are configured to cause the system to calculate a gradient of a joint loss function based on the first output, on the second output, and on a target. Additionally, the one or more processors are configured to cause the system to modify the neural network based on the gradient.

In some embodiments, one or more computer-readable media store instructions that, when executed by one or more computing devices, cause the one or more computing devices to obtain a set of digital images; select a first pair of digital images, which includes a first image and a second image; and forward propagate the first image through a neural network, thereby generating a first output. Also, when executed, the instructions cause the one or more computing devices to forward propagate the second image through the neural network, thereby generating a second output. Furthermore, when executed, the instructions cause the one or more computing devices to calculate a gradient of a joint loss function based on the first output, on the second output, and on a first target. Additionally, when executed, the instructions cause the one or more computing devices to modify the neural network based on the gradient.

### BRIEF DESCRIPTION OF THE DRAWINGS

FIG. 1 illustrates an example embodiment of the flow of operations in a system for training a neural network with a joint loss function.

FIG. 2 illustrates an example embodiment of the flow of operations in a system for training a neural network with a joint loss function.

FIG. 3 illustrates an example embodiment of a neural network that is trained with a pairwise constraint.

FIG. 4 illustrates an example embodiment of a neural network that is trained with a pairwise constraint.

FIG. 5 illustrates an example embodiment of an operational flow for training a neural network with a joint loss function.

FIG. 6 illustrates an example embodiment of an operational flow for training a neural network with a joint loss function.

FIG. 7 illustrates an example embodiment of an operational flow for updating a neural network.

FIG. 8 illustrates an example embodiment of a system for training a neural network with a joint loss function.

### DESCRIPTION

The following disclosure describes certain explanatory embodiments. Other embodiments may include alternatives, equivalents, and modifications. Additionally, the explanatory embodiments may include several novel features, and a particular feature may not be essential to some embodiments of the devices, systems, and methods that are described herein.

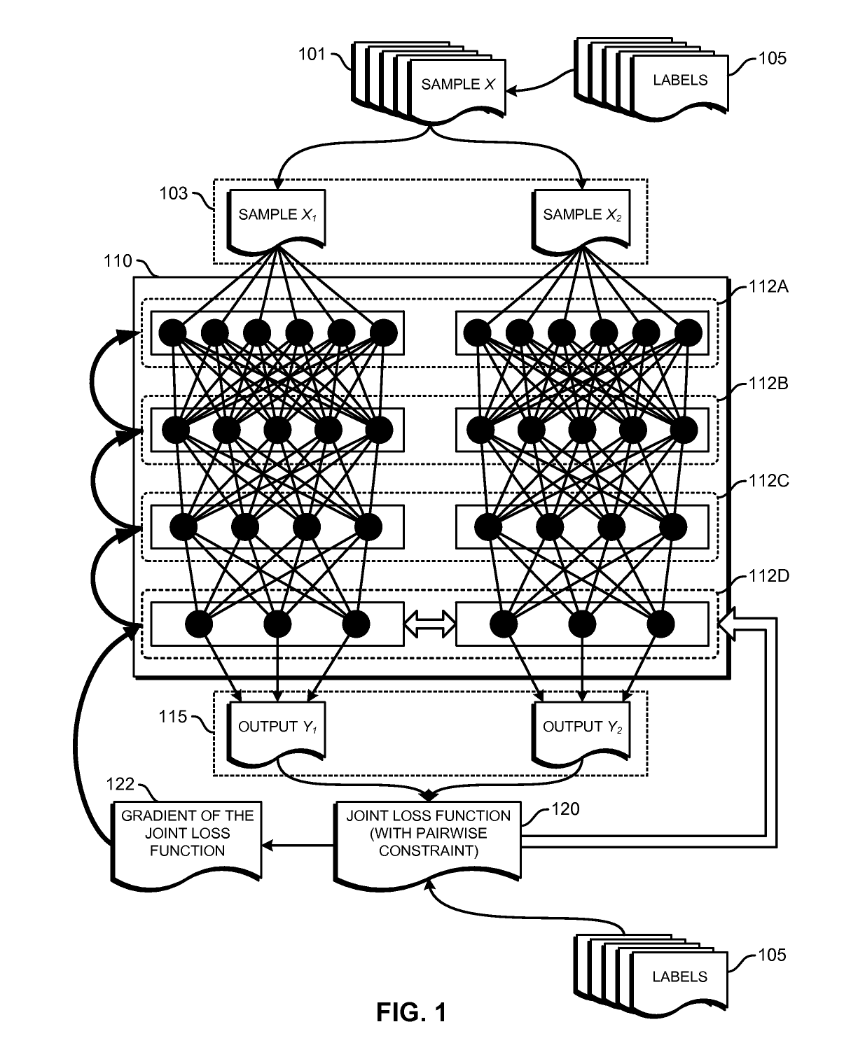

FIG. 1 illustrates an example embodiment of the flow of operations in a system for training a neural network with a joint loss function. The system uses side information and introduces a pairwise constraint at a layer of the neural network to improve both classification and retrieval tasks. The system produces features that may capture high-level category information while also being suitable for nearest-neighbor-based large-scale retrieval tasks. Also, the system can employ adaptive margin-based pairwise encoding with deep neural networks. Thus, the system can learn non-linear mappings or embeddings of feature representations for different tasks.

In some embodiments, the system adds a pairwise-constraint error term to a classification objective function to create a joint loss function. By jointly minimizing the two error terms, the learned features may be more discriminative than cross-entropy based features while still being suitable for retrieval tasks, such as nearest-neighbor matching. The system may use the joint loss function on one or more layers of the neural network. Furthermore, embodiments of the system may use a convolutional neural network or a recurrent neural network. Also, some embodiments may pre-train the neural network, for example by using a Restricted Boltzmann Machine.

The system obtains a group of n training samples 101 (e.g., images, segments of images), where the d-dimensional samples 101 may each be in the form of a matrix Xε [symbol] ^{n×d}. In this embodiment, the samples 101 are respectively labeled with one or more labels 105, which are an example of side information. The system inputs a pair of samples 103 into a neural network 110. In some embodiments, both samples in the pair of samples 103 are images or segments of images, and, in some embodiments, one sample is an image (or a segment of an image) and the other sample is text. Also, in some embodiments, the value of each pixel in an image is used as an input to a corresponding node in the first layer 112A of the neural network 110. Thus, in these embodiments there is a one-to-one relationship of pixels in a sample 101 to nodes in the first layer 112A. The system then forward propagates the pair of samples 103, which includes a first sample X₁ and a second sample X₂, through the neural network 110.

This embodiment of a neural network 110 includes four layers 112 (the first layer 112A, a second layer 112B, a third layer 112C, and a fourth layer 112D), although other embodiments may include more or fewer layers 112. The forward propagation through the neural network 110 generates a pair of outputs 115 of the neural network that are based on the inputs, and the inputs are the first sample X₁ and the second sample X₂ in this example. The outputs in the pair of outputs 115 each may be in the form of an s-dimensional matrix Yε [symbol] ^{n×s}. The pair of outputs 115 includes a first output of the neural network Y₁ (“first output Y₁”) and a second output of the neural network Y₂ (“second output Y₂”). The first output Y₁ is generated from the forward propagation of the first sample X₁ through the neural network 110, and the second output Y₂ is generated from the forward propagation of the second sample X₂ through the neural network 110.

Also, in some embodiments, the number of nodes in the deepest layer (also referred to herein as the output layer), which is the fourth layer 112D in this example, is equal to the number of labels in the set of labels 105 that can be applied to a sample. For example, if there are one hundred possible labels 105 that can be applied to a sample, then the deepest layers of these embodiments have one hundred nodes.

Next, the system updates the neural network 110. Some embodiments of the system update the neural network 110 using backward propagation of errors with gradient descent. While updating the neural network 110, the system calculates the gradient 122 of a joint loss function J(W,b) 120 based on the first output Y₁, on the second output Y₂, on the labels 105 of the first sample X₁, on the labels 105 of the second sample X₂, and on a pairwise constraint that is applied at a pairwise-constraint layer of the neural network 110. In the joint loss function J(W,b) 120, W represents the weights and b represents the bias.

In this embodiment, the pairwise-constraint layer is the fourth layer 112D, which is the deepest layer of the neural network 110 in FIG. 1, although in other embodiments, the pairwise-constraint layer may be another layer 112. Therefore, in this embodiment, the gradient 122 of the joint loss function J(W,b) 120 is calculated for the fourth layer 112D. After the gradient is calculated for the fourth layer 112D, the system calculates the gradients for the other layers, for example through backward propagation of errors (backpropagation) of the gradient 122 of the joint loss function 120 through the remaining layers 112 using a cross-entropy loss function. Also, the system modifies the output layer 112D based on the gradient 122 of the joint loss function J(W,b) 120, and the system modifies the other layers 112 (which, in this embodiment, include the third layer 112C, the second layer 112B, and the first layer 112A) based on the backpropagation of the gradient 122 of the joint loss function J(W,b) 120.

The system may perform multiple training iterations, and, in each of the training iterations, a pair of samples 103 is input to the neural network 110 and a pair of outputs 115 is generated. Also, the update operations may generate two updated copies of the neural network 110, one copy per sample, and the system may select one of the copies as the updated neural network 110.

The joint loss function J(W,b) 120 combines a cross-entropy loss function J_{C} and a contrastive loss function J_{P}, and it can be calculated according to

J(W,b)=α₁f_{C}(W,b)+α₂J_{P}(W,b), (1)

where α₁ and α₂ respectively control the contributions of the cross-entropy loss function J_{C} and the contrastive loss function J_{P}.

In some embodiments, the cross-entropy loss function J_{C} is a discriminative error term that is the cross-entropy of an output Y and a target T, which is the expected or desired output of a corresponding input X. Depending on the embodiment, the target T may be the labels 105 (e.g., for classification tasks), or the target T may be the input sample X (e.g., for reconstruction tasks, such as an autoencoder). Some embodiments (e.g., embodiments that classify inputs) calculate the cross-entropy loss function J_{C} according to

J_{C}(W,b)=−T*ln Y, (2)

where the target T is the labels 105 (e.g., labels which identify the ground truth), and where Y is the output of the neural network (e.g., output Y₁, output Y₂).

Moreover, in some embodiments (e.g., embodiments that use semi-supervised learning), some of the samples 101 are labeled and some of the samples 101 are not labeled. However, if one sample of a pair of samples 103 is labeled with one or more labels 105, and if the other sample is known to be similar to the labeled sample, then the labels 105 from the labeled sample can be applied to the unlabeled sample. Also, some embodiments use a binary judgment or a confidence-based judgment of the similarity of the samples in a pair of samples 103, and the binary judgement and the confidence-based judgment are also examples of side information.

Furthermore, some embodiments use unsupervised learning (e.g., an autoencoder). In these embodiments, the goal is to make the output Y the same as the input sample X, because the objective is to reconstruct the input sample X as much as possible. Thus, some embodiments can calculate the cross-entropy loss function J_{C} according to

J_{C}(W,b)=−T*ln X. (3)

In addition to the cross-entropy loss function J_{C}, the joint loss function J(W,b) 120 includes a contrastive loss function J_{P}. The contrastive loss function J_{P} works on a pair of inputs. Also, the contrastive loss function J_{P} may be a distance-based objective function. If {x₁, x₂} is a pair of inputs, and if l is a binary label assigned to this pair, then

$$l = \{ \begin{matrix}0 , & if {x}_{1} and {x}_{2} are similar \\ 1 , & otherwise\end{matrix} . \qquad ( 4 )$$

Furthermore, some embodiments calculate the contrastive loss function J_{P} based on the distance D_{W} between a first input x₁ and a second input x₂ as the Euclidean distance between their corresponding outputs G_{W}(x₁) and G_{W}(x₂), which are the corresponding outputs of the layer 112 of the neural network 110 where the pairwise constraint is applied. For example, these embodiments may calculate the distance D_{W} according to

D_{W}(x₁,x₂)=∥G_{W}(x₁)−G_{W}(x₂)∥₂, (5)

where G_{W} is the activation function of the layer 112 (e.g., the output layer 112D in FIG. 1) where the pairwise constraint is applied. Additionally, some embodiments use softmax and use the output of the softmax layer as y. Therefore, in some embodiments, the learned distance D_{W} between a first input x₁ and a second input x₂ is calculated according to

D_{W}(x₁,x₂)=∥y₁−y₂∥₂, (6)

where y₁ and y₂ are, respectively, the outputs of G_{W}(x₁) and G_{W}(x₂) and may be calculated according to equation (14) below.

Also, a contrastive loss function J_{P} that is based on a pair of inputs {x₁, x₂} may be calculated according to

$${J}_{P} ( W , b ) = {\sum }_{i = 1}^{P} {J}_{P} ( W , b , {( l , {x}_{1} , {x}_{2} )}^{i} ) , \qquad ( 7 )$$

where

J_{P}(W,b,(l,x₁,x₂)ⁱ)=(1−l)J_{S}(D_{w}ⁱ)+lJ_{D}(D_{w}ⁱ). (8)

As used herein, D_{W} refers to D_{W} (x₁, x₂), and J_{S}(D_{W}) and J_{D} (D_{W}) refer to partial loss functions for similar pairs and dissimilar pairs, respectively. Also, the partial loss function for similar pairs J_{S}(D_{W}) may be calculated according to

J_{S}(W,b,D_{W})=½(D_{W})², (9)

and the partial loss function for dissimilar pairs J_{D}(D_{W}) may be calculated according to

J_{D}(W,b,D_{W})=½{max(0,m−D_{W})}². (10)

The preceding contrastive loss function applies a single margin m to the dissimilar component. However, one goal for pairwise encoding is to push dissimilar pairs farther away from each other and to push similar pairs closer to each other, so that a nearest neighbor classifier can take advantage of the distance distinction. Thus, one goal is to pull all the samples in similar pairs to be closer than the samples in dissimilar pairs, rather than pulling all the samples in similar pairs into respective identical points, which may require extra effort. Hence, some embodiments use bi-margins that are applied to both the similar side and the dissimilar side. In this way, the learning may be stopped when all of the similar pairs are closer than the dissimilar pairs. Thus, the learning may be stopped earlier. Accordingly, in some embodiments the contrastive loss function J_{P} is calculated according to

J_{P}(W,b,(l,x₁,x₂)ⁱ)=(1−l)J_{S}(D_{w}ⁱ)+lJ_{D}(D_{w}ⁱ), (11)

where the partial loss function for similar pairs J_{S}(D_{W}) may be calculated according to

J_{S}(W,b,D_{W})=½{max(0,D_{W}−mₛ)}², (12)

and where mₛ is the margin for similar pairs. Also, the partial loss function for dissimilar pairs J_{D}(D_{W}) may be calculated according to

J_{D}(W,b,D_{W})=½{max(0,m_{d}−D_{W})}², (13)

where m_{d} is the margin for dissimilar pairs.

To train the neural network 110, the system may optimize the joint loss function J(W,b) 120. Also, an arbitrary activation function can be used in the neural network 110. For example, some embodiments use softmax as the activation function of a layer 112 (e.g., the final layer 112D) in the neural network 110 (e.g., a neural network for classification). Given z as the input to the softmax layer (e.g., layer 112D) of the neural network 110, where the input z has k dimensions, the output yⱼ of a node of the softmax layer may be calculated according to

$${y}_{j} = softmax ( {z}_{j} ) = \frac{{e}^{{z}_{j}}}{{\sum }_{i = 1}^{k} {e}^{{z}_{i}}} , \\ where \\ j = 1 , … , k , \qquad ( 14 )$$

where yⱼ is the output of the j-th node. The output Y={y₁, y₂, . . . , yₖ} of the softmax layer, where yⱼ is a confidence-rated output from 0 to 1, may have a low dimensionality, and the dimensionality may be the same as the number of target classes (e.g., the number of labels 105) when the number of target classes is k. The derivative of softmax may be calculated according to

$$\frac{\partial {y}_{i}}{\partial {z}_{i}} = {y}_{i} ( 1 - {y}_{i} ) , \qquad ( 15 )$$

and, when j is not equal to i, then it may be calculated according to

$$\frac{\partial {y}_{j}}{\partial {z}_{i}} = - {y}_{i} {y}_{j} , \qquad ( 16 )$$

where i and j are indexes of the nodes in the layer.

Therefore, in the embodiment of FIG. 1, where the gradient of the joint loss function 122 is calculated at the output layer 112D (i.e., the fourth layer 112D in FIG. 1), the outputs Y (e.g., output Y₁ and output Y₂) are used to calculate the cross-entropy loss using the labels 105 as the target T. When calculating the derivative of the cross-entropy loss function J_{C}(W,b)=−T*ln Y at the output layer 112D, for each input element zᵢ to the output element yᵢ, the partial derivative is

$$\begin{matrix}\frac{\partial {J}_{C}}{\partial {z}_{i}} = \frac{\partial {J}_{C}}{\partial {y}_{i}} \frac{\partial {y}_{i}}{\partial {z}_{i}} = - ( \frac{\partial {t}_{i} ln {y}_{i}}{\partial {y}_{i}} \frac{\partial {y}_{i}}{\partial {z}_{i}} + {\sum }_{j \neq i} \frac{\partial {t}_{j} ln {y}_{j}}{\partial {y}_{i}} \frac{\partial {y}_{i}}{\partial {z}_{i}} ) \\ = - ( \frac{{t}_{i}}{{y}_{i}} {y}_{i} ( 1 - {y}_{i} ) ) + {\sum }_{j \neq i} ( \frac{{t}_{j}}{{y}_{j}} {y}_{i} {y}_{j} ) \\ = - ( {t}_{i} - {y}_{i} \sum {t}_{j} ) \\ = {y}_{i} - {t}_{i} ,\end{matrix} \qquad ( 17 )$$

where Σtⱼ=1, where the target T={t₁, t₂, . . . , tₙ}, and where n is the number of dimensions in the target T.

This learning is also applicable to embodiments that calculate the cross-entropy loss according to J_{C}(W,b)=−T*ln Y. The difference is the source of the target T, which is either the labels 105 or a corresponding original input sample 101 (e.g., the first sample X₁, the second sample X₂).

Additionally, the contrastive loss function J_{P} may have two parts: one part is for similar pairs, and the other part is for dissimilar pairs. In these embodiments, the derivative of the contrastive loss function J_{P} may be calculated according to

$$\frac{\partial {J}_{P}}{\partial {z}_{i}} = ( 1 - l ) \frac{\partial {J}_{S}}{\partial {z}_{i}} + l \frac{\partial {J}_{D}}{\partial {z}_{i}} . \qquad ( 18 )$$

In some of the embodiments that use a similar margin constraint mₛ, only the similar pairs, where D_{W}≧mₛ, are relevant. Also, when the margin constraint mₛ=0, the result may be equivalent to embodiments that do not have a similar margin constraint mₛ. The partial derivative for the partial loss function for similar pairs J_{S}(D_{W}) in a layer can be calculated according to

$$\begin{matrix}\frac{\partial {J}_{S} ( {D}_{W} )}{\partial {z}_{i}} = \frac{1}{2} \frac{\partial {( {D}_{W} - {m}_{s} )}^{2}}{\partial {z}_{i}} = ( {D}_{W} - {m}_{s} ) \frac{\partial {D}_{W}}{\partial {z}_{i}} \\ = {D}_{W} \frac{\partial {‖ {y}_{1} - {y}_{2} ‖}_{2}}{\partial {z}_{i}} \\ = \frac{1}{2} \frac{( {D}_{W} - {m}_{s} )}{{D}_{W}} \frac{\partial \sum {( {y}_{1 j} - {y}_{2 j} )}^{2}}{\partial {z}_{i}} \\ = \frac{( {D}_{W} - {m}_{s} )}{{D}_{W}} \sum ( {y}_{1 j} - {y}_{2 j} ) \frac{\partial ( {y}_{1 j} - {y}_{2 j} )}{\partial {z}_{i}} \\ = \frac{( {D}_{W} - {m}_{s} )}{{D}_{W}} ( {y}_{1 i} - {y}_{2 i} ) \frac{\partial ( {y}_{1 i} - {2}_{2 i} )}{\partial {z}_{i}} + \\ \frac{( {D}_{W} - {m}_{s} )}{{D}_{W}} {\sum }_{j \neq i} ( {y}_{1 j} - {y}_{2 j} ) \frac{\partial ( {y}_{1 j} - {y}_{2 j} )}{\partial {z}_{i}} \\ = \frac{( {D}_{W} - {m}_{s} )}{{D}_{W}} ( {y}_{1 i} - {y}_{2 i} ) ( {y}_{1 i} - {y}_{2 i} - {y}_{1 i}^{2} + {y}_{2 i}^{2} ) + \\ \frac{( {D}_{W} - {m}_{s} )}{{D}_{W}} {\sum }_{j \neq i} ( {y}_{1 j} - {y}_{2 i} ) ( - {y}_{1 j} {y}_{1 i} + {y}_{2 j} {y}_{2 i} ) \\ = \frac{( {D}_{W} - {m}_{s} )}{{D}_{W}} \{ \begin{matrix}{( {y}_{1 i} - {y}_{2 i} )}^{2} - \\ \sum ( {y}_{1 j} - {y}_{2 j} ) ( {y}_{1 j} {y}_{1 i} - {y}_{2 j} {y}_{2 i} )\end{matrix} \} ,\end{matrix} \qquad ( 19 )$$

where y₁ᵢ is the i-th element of the first output y₁ of the layer, where y₁ⱼ is the j-th element of the first output y₁ of the layer, where y₂ᵢ is the i-th element of the second output y₂ of the layer, where y₂ⱼ is the j-th element of the second output y₂ of the layer, and where mₛ is a similar margin constraint.

Regarding the partial loss function for dissimilar pairs J_{D}(D_{W}),J_{D}=0 when D_{W}≧m_{d}. Thus, only the situations where D_{W}<m_{d} may be relevant. In some embodiments, the partial derivative of the partial loss function for dissimilar pairs J_{D}(D_{W}) in a layer is calculated according to

$$\begin{matrix}\frac{\partial {J}_{D} ( {D}_{W} )}{\partial {z}_{i}} = \frac{1}{2} \frac{\partial {( {m}_{d} - {D}_{W} )}^{2}}{\partial {z}_{i}} = - ( {m}_{d} - {D}_{W} ) \frac{\partial {D}_{W}}{\partial {z}_{i}} \\ = \frac{( {D}_{W} - {m}_{d} )}{{D}_{W}} \{ \begin{matrix}{( {y}_{1 i} - {y}_{2 i} )}^{2} - \\ \sum ( {y}_{1 j} - {y}_{2 j} ) ( {y}_{1 j} {y}_{1 i} - {y}_{2 j} {y}_{2 i} )\end{matrix} \} ,\end{matrix} \qquad ( 20 )$$

where y₁ᵢ is the i-th element of the first output y₁ of the layer, where y₁ⱼ is the j-th element of the first output y₁ of the layer, where y₂ᵢ is the i-th element of the second output y₂ of the layer, where y₂ⱼ is the j-th element of the second output y₂ of the layer, and where m_{d} is a dissimilar margin constraint.

The optimization for the joint loss function J(W,b) may be calculated based on the derivative of the joint loss function J(W,b). The derivative of the joint loss function J(W,b) may be a linear representation of the derivatives of the cross-entropy loss function J_{C}(W,b) and the contrastive loss function J_{P}(W,b). For example, the derivative of the joint loss function J(W,b) in an output layer may be calculated according to

$$\begin{matrix}\frac{\partial J}{\partial {z}_{i}} = {α}_{1} \frac{\partial {J}_{C}}{\partial {z}_{i}} + {α}_{2} \frac{\partial {J}_{P}}{\partial {z}_{i}} \\ = {α}_{1} ( {y}_{1 i} - {t}_{1 i} ) + {α}_{1} ( {y}_{2 i} - {t}_{2 i} ) + \\ {α}_{2} \frac{( {D}_{W} - m )}{{D}_{W}} \{ \begin{matrix}{( {y}_{1 i} - {y}_{2 i} )}^{2} - \\ {α}_{2} \sum ( {y}_{1 j} - {y}_{2 j} ) ( {y}_{1 j} {y}_{1 i} - {y}_{2 j} {y}_{2 i} )\end{matrix} \} ,\end{matrix} \qquad ( 21 )$$

where m=mₛ for similar pairs, and where m=m_{d} for dissimilar pairs.

Also for example, the derivative of the joint loss function J(W,b) in layer that is not the output layer may be calculated according to

$$\begin{matrix}\frac{\partial J}{\partial {z}_{i}} = {α}_{1} \frac{\partial {J}_{C}}{\partial {z}_{i}} + {α}_{2} \frac{\partial {J}_{P}}{\partial {z}_{i}} \\ = {α}_{1} ( {δ}_{1} ) + {α}_{1} ( {δ}_{2} ) + \\ {α}_{2} \frac{( {D}_{W} - m )}{{D}_{W}} \{ \begin{matrix}{( {y}_{1 i} - {y}_{2 i} )}^{2} - \\ {α}_{2} \sum ( {y}_{1 j} - {y}_{2 j} ) ( {y}_{1 j} {y}_{1 i} - {y}_{2 j} {y}_{2 i} )\end{matrix} \} ,\end{matrix} \qquad ( 22 )$$

where δ₁ is a backpropagated value (e.g., error) that is based on a first output Y₁ of the neural network and on the first target T₁, and where δ₂ is a backpropagated value that is based on a second output Y₂ of the neural network and on the second target T₂. For example, equation (22) can be used by embodiments that calculate the derivative of the joint loss function at a layer that is not the output layer. In these embodiments, the errors (which are δ in equation (22)) from the cross-entropy loss function are backpropagated from the output layer to the pairwise-constraint layer.

Furthermore, balancing the contributions α₁ and α₂ of the cross-entropy loss function J_{C} and the contrastive loss function J_{P} to the joint loss function J(W,b) may be important in view of the underlying difference of the scale of their ranges. Thus, to select the respective contributions α₁ and α₂ for J_{C}(W,b) and J_{P}(W,b) in order to balance the objectives, some embodiments first choose a primer model, for example α₁ for J_{C}(W,b), then keep its scale unchanged. At the same time, these embodiments let another model, for example α₂ for J_{P}(W,b), scale-up or scale-down to match the loss value or a portion of J_{C}(W,b). Thus, these embodiments can avoid single-model domination of the learning and allow a user to choose a preference between the different models of the joint loss function J(W,b) and their objectives.

Furthermore, when training a neural network 110 with a set of samples 101, some embodiments use every possible pair combination of samples 101 in an epoch, and therefore each sample 101 is pairwise compared to every other sample 101 in an epoch. However, some embodiments do not use every possible combination of sample pairs in an epoch.

After the neural network 110 has been trained, query images may be input into the neural network 110, and the outputs of the nodes of a certain layer 112 of the neural network 110 can be used as the feature representation of the respective query image. For example, some embodiments use the outputs of the nodes of the smallest layer 112 (the layer that has the fewest nodes) of the neural network 110 as the features of the feature representation. In FIG. 1, the smallest layer 112 is the fourth layer 112D. Also for example, other embodiments use the outputs of the nodes at the deepest layer 112 of the neural network 110 as the features of the feature representation. Although the deepest layer 112 is the same as the smallest layer 112 in FIG. 1, in some embodiments these layers are not the same.

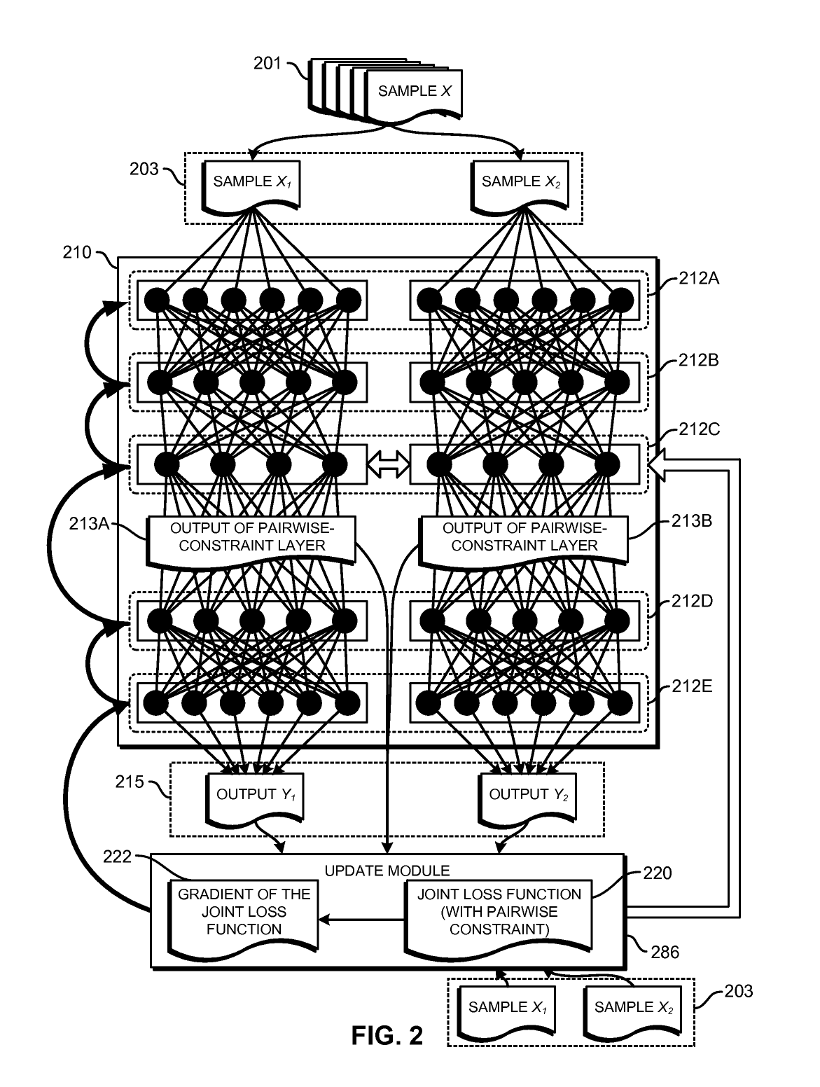

FIG. 2 illustrates an example embodiment of the flow of operations in a system for training a neural network with a joint loss function. The system obtains a group of n training samples 201, and the system forward propagates a pair of training samples 203, which includes a first sample X₁ and a second sample X₂, through a neural network 210. This embodiment of a neural network 210 includes five layers 212 (a first layer 212A, a second layer 212B, a third layer 212C, a fourth layer 212D, and a fifth layer 212E). During forward propagation of the first sample X₁ and the second sample X₂, a respective output is generated by each layer 212 of the neural network 210. These outputs include a first output 213A of the pairwise-constraint layer 212C and a second output 213B of the pairwise-constraint layer 212C. The first output 213A of the pairwise-constraint layer 212C is generated during the forward propagation of the first sample X₁ through the neural network 210, and the second output 213B of the pairwise-constraint layer 212C is generated during the forward propagation of the second sample X₂ through the neural network 210.

The forward propagation through the neural network 210 generates a pair of outputs 215 of the neural network 210 at the output layer 212E, and the outputs 215 are based on the pair of training samples 203. This pair of outputs 215 includes a first output Y₁ and a second output Y₂. The first output Y₁ is generated from the forward propagation of the first sample X₁ through the neural network 210, and the second output Y₂ is generated from the forward propagation of the second sample X₂ through the neural network 210. Next, an update module 286 of the system obtains the pair of outputs 215 of the neural network 210 and obtains the pair of training samples 203.

Additionally, the update module 286 obtains the first output 213A of the pairwise-constraint layer 212C and obtains the second output 213B of the pairwise constraint layer 212C.

The update module 286 then calculates a gradient of a cross-entropy loss function based on one or more of the pair of outputs 215 and on one or more of the pair of training samples 203, and the update module 286 backpropagates the gradient of the cross-entropy loss function through the neural network 210. When the backpropagation reaches the pairwise-constraint layer 212C, the update module 286 calculates a gradient 222 of the joint loss function 220 based on the first output Y₁ of the neural network 210, on the second output Y₂ of the neural network 210, on the pair of training samples 203, on the first output 213A of the pairwise-constraint layer 212C, and on the second output 213B of the pairwise-constraint layer 212C. The gradient 222 of the joint loss function 220 is then backpropagated through the higher levels (i.e., levels 212A-B) of the neural network 210. Also, the update module 286 modifies the neural network 210 (e.g., modifies the weights of the nodes in the neural network 210) based on the backpropagation.

For example, to calculate the gradient 222 of the joint loss function 220 based on the first output Y₁, on the second output Y₂, on the pair of training samples 203, on the first output 213A of the pairwise-constraint layer 212C, and on the second output 213B of the pairwise-constraint layer 212C, some embodiments of the system first calculate two gradients of a cross-entropy loss function: one gradient is calculated based on the first output Y₁ and the first sample X₁, and the second gradient is calculated based on the second output Y₂ and on the second sample X₂. These embodiments then backpropagate the two gradients of the cross-entropy loss function though respective copies of the neural network 210 until the backpropagations reach the pairwise-constraint layer 212C of the neural network 210.

When the backpropagations reach the pairwise-constraint layer 212C of the neural network 210, these embodiments calculate the gradient 222 of the joint loss function 220 based on the first output 213A of the pairwise-constraint layer 212C, on the second output 213B of the pairwise-constraint layer 212C, and on the backpropagated gradients of the cross-entropy loss function. For example, at the pairwise-constraint layer 212C, to calculate the cross-entropy-loss-function portion of the gradient 222, these embodiments may use the backpropagated gradients of the cross-entropy loss function. Also, these embodiments may calculate the contrastive-loss-function portion of the gradient 222 based on the first output 213A of the pairwise-constraint layer 212C and on the second output 213B of the pairwise-constraint layer 212C.

Thus, although these embodiments may calculate gradients of the layers 212 where the pairwise constraint is not applied according to only the cross-entropy loss function, when the backpropagation reaches the pairwise-constraint layer 212C of the neural network 210, the gradient 222 is calculated based on the joint loss function 220. Also, the values used during the backpropagation through the higher layers 212 (e.g., layers 212A-B in FIG. 2), which may be calculated according to only the cross-entropy loss function, are dependent on the backpropagated gradient 222 of the joint loss function 220.

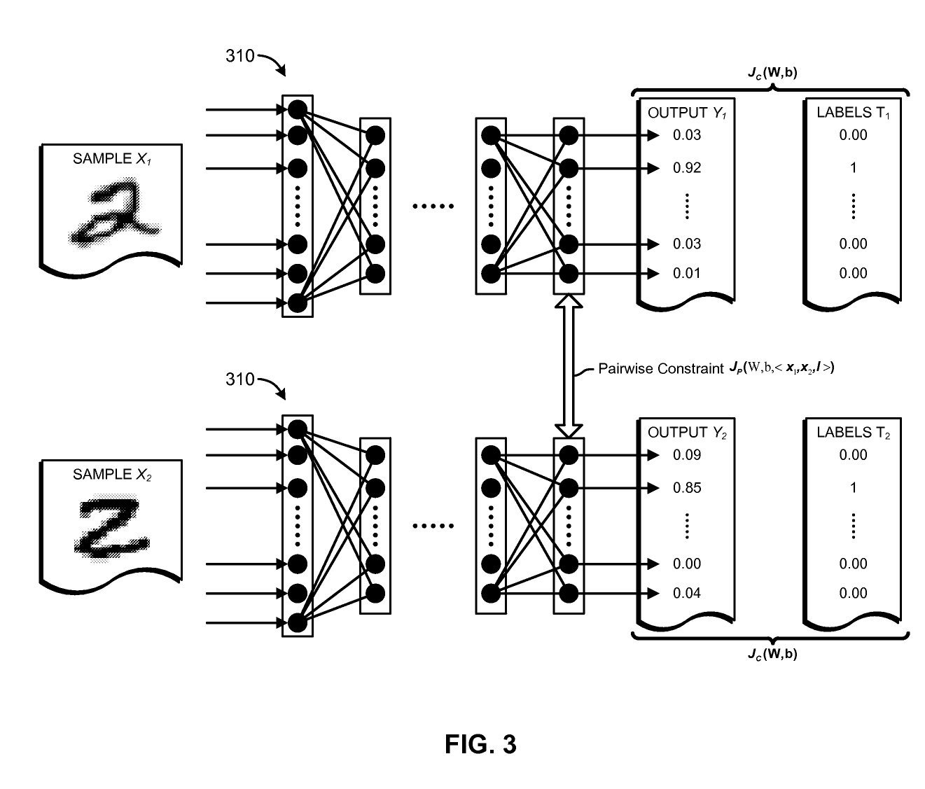

FIG. 3 illustrates an example embodiment of a neural network 310 (two copies of the neural network 310 are shown) that is trained with a pairwise constraint. A first sample X₁ is input into the neural network 310. The first sample X₁ has been labeled with first labels T₁. Forward propagation of the first sample X₁ through the neural network 310 produces a first output Y₁, which includes at least output units 0.03, 0.92, 0.03, and 0.01. Also, a second sample X₂ is input into the neural network 310, and forward propagation of the second sample X₂ through the neural network 310 produces a second output Y₂, which includes at least output units 0.09, 0.85, 0.00, and 0.04. The second sample X₂ has been labeled with second labels T₂.

Then, while updating the neural network 310, the gradient at the deepest layer of the neural network 310 is calculated based on the joint loss function J(W,b). For example, the gradient may be calculated according to equation (21), where the cross-entropy loss function J_{C}(W,b) is calculated using the first output Y₁ and the first labels T₁ and using the second output Y₂ and the second labels T₂, and where the contrastive loss function J_{P}(W,b,<x₁,x₂,l>) is calculated using the first output Y₁ and the second output Y₂. Thus, in this example, the contrastive loss function J_{P}(W,b,<x₁, x₂,l>) applies a pairwise constraint at the deepest layer of the neural network 310. Also, this embodiment may use a cross-entropy loss function J_{C}(W,b) for classification and may calculate J_{C}(W,b) according to equation (2), where the first labels T₁ or the second labels T₂ are used as the target T. For example, if the first labels T₁ are used as the Target T, then T={0.00,1, . . . ,0.00,0.00}.

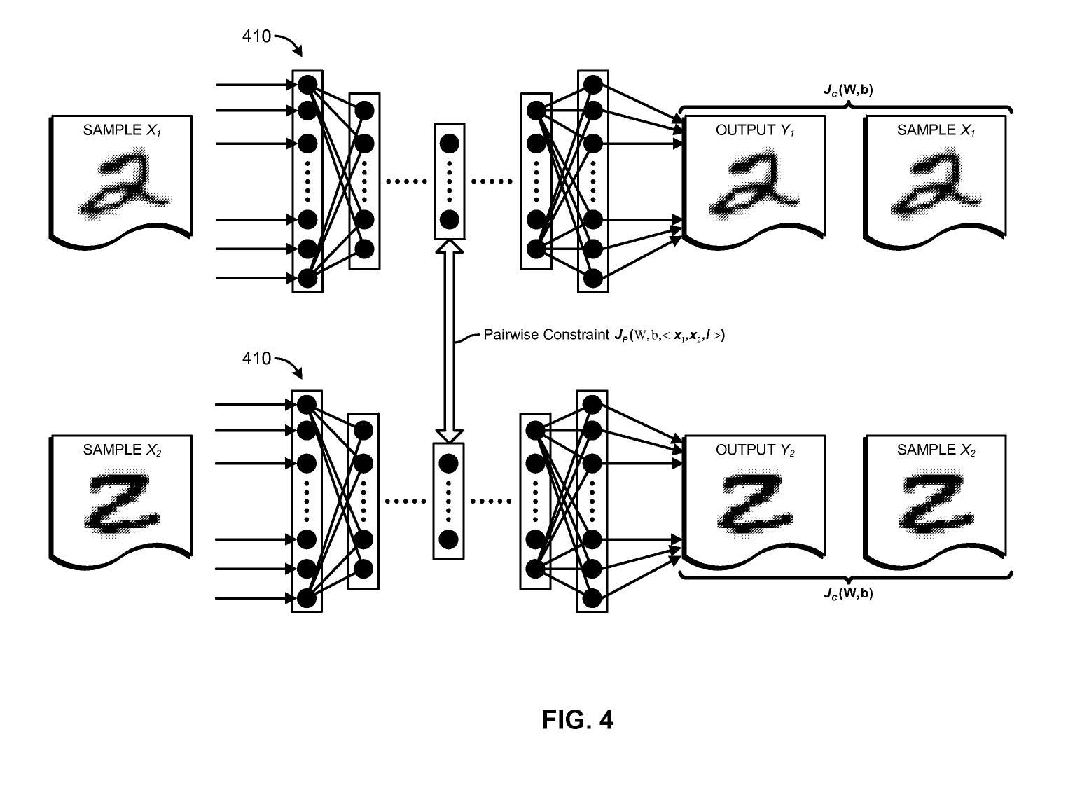

FIG. 4 illustrates an example embodiment of a neural network 410 (two copies of the neural network 410 are shown) that is trained with a pairwise constraint. A first sample X₁ is input into the neural network 410, and forward propagation of the first sample X₁ through the neural network 410 produces a first output Y₁. Also, a second sample X₂ is input into the neural network 410, and forward propagation of the second sample X₂ through the neural network 410 produces a second output Y₂. Then the neural network 410 is updated.

While updating the neural network 410, gradients of a cross-entropy loss function J_{C}(W,b) are backpropagated through the copies of the neural network 410. Accordingly, the gradients for the layers of the neural network 410 that do not have the pairwise constraint may be generated according to only the cross-entropy loss function J_{C}(W,b). Thus, these layers are modified according to backpropagation that is based on the first output Y₁ and the first target T₁ or according to backpropagation that is based on the second output Y₂ and the second target T₂.

As the neural network 410 is updated, the gradient at the pairwise-constraint layer, which is the smallest layer in this example, is calculated based on the joint loss function J(W,b), for example according to equation (22). The cross-entropy-loss portion at the pairwise-constraint layer may be calculated using one or both of the backpropagated values that are based on the first output Y₁ and the first sample X₁ and the backpropagated values that are based on the second output Y₂ and the second sample X₂.

Furthermore, the contrastive loss function J_{P}(W,b,<x₁, x₂,l>), which is calculated using the first output y₁ of the pairwise-constraint layer and the second output y₂ of the pairwise-constraint layer, applies the pairwise constraint at a layer of the neural network 410 that is not the deepest layer. The first output y₁ of the pairwise-constraint layer is the output of the pairwise-constraint layer that was generated when the first sample X₁ was forward propagated through the neural network 410, and the second output y₂ of the pairwise-constraint layer is the output of the pairwise-constraint layer that was generated when the second sample X₂ was forward propagated through the neural network 410.

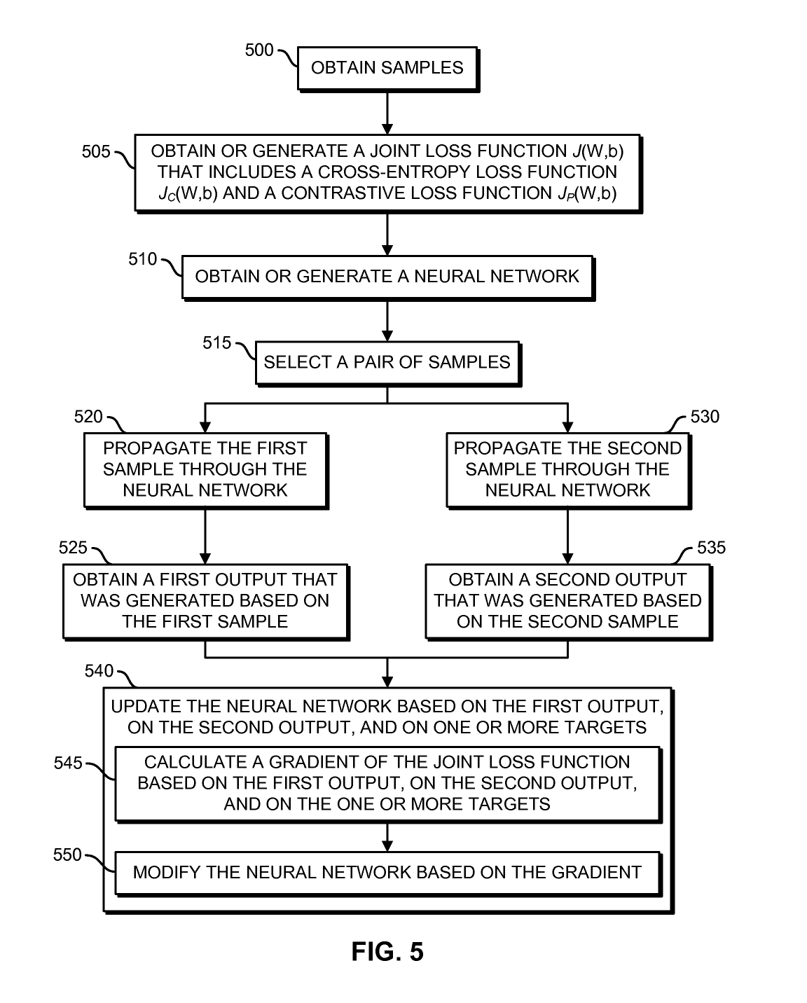

FIG. 5 illustrates an example embodiment of an operational flow for training a neural network with a joint loss function. The blocks of this operational flow and the other operational flows that are described herein may be performed by one or more computing devices, for example the computing devices that are described herein. Also, although this operational flow and the other operational flows that are described herein are each presented in a certain order, some embodiments may perform at least some of the operations in different orders than the presented orders. Examples of possible different orderings include concurrent, overlapping, reordered, simultaneous, incremental, and interleaved orderings. Thus, other embodiments of this operational flow and the other operational flows that are described herein may omit blocks, add blocks, change the order of the blocks, combine blocks, or divide blocks into more blocks.

The flow starts in block 500, where samples are obtained. Next, in block 505, a joint loss function J(W,b) that includes a cross-entropy loss function J_{C}(W,b) and a contrastive loss function J_{P}(W,b) is generated or obtained. The flow then moves to block 510, where a neural network is obtained or generated. The number of layers in the neural network and the number of nodes in each layer may be selected according to various criteria. Following, in block 515, a pair of samples is selected.

The flow then splits into a first flow and a second flow. The first flow moves to block 520, where the first sample of the pair of samples is forward propagated through the neural network. Some computing devices and methods make a copy of the neural network in memory and propagate the first sample through the copy of the neural network. In block 525, a first output that was generated based on the first sample is obtained. The first output includes a first output of the neural network and a first output of the pairwise-constraint layer. The first flow then moves to block 540.

Also, the second flow moves to block 530, where the second sample is forward propagated through the neural network. To perform blocks 520 and 530 in parallel, some computing devices make an additional copy of the neural network in memory and propagate the second sample through the additional copy of the neural network. In block 535, a second output that was generated based on the second sample is obtained. The second output includes a second output of the neural network and a second output of the pairwise-constraint layer. The second flow then moves to block 540.

In block 540, the neural network is updated based on the first output, on the second output, and on one or more targets. For example, the neural network may be updated using backward propagation of errors. Block 540 includes the operations of block 545 and block 550.

In block 545, at a pairwise-constraint layer, a gradient of the joint loss function is calculated based on the first output, on the second output, and on one or more targets. The calculation of the gradient of the joint loss function may directly use the first output of the neural network and the second output of the neural network (e.g., according to equation (21)), for example when the pairwise-constraint layer is the deepest layer in the neural network. Also, the calculation of the gradient of the joint loss function may use backpropagated values that are based on the first output of the neural network and use backpropagated values that are based on the second output of the neural network (e.g., according to equation (22)), for example when the pairwise-constraint layer is not the deepest layer in the neural network. Furthermore, the calculation of the gradient of the joint loss function may directly use the first output of the pairwise-constraint layer, which was generated during forward propagation of the first sample through the neural network in block 520, and the second output of the pairwise-constraint layer, which was generated during forward propagation of the second sample through the neural network in block 530.

For example, if the pairwise-constraint layer is the output layer, then in equation (21), the first output y₁ of the layer may be the first output of the neural network, which was obtained in block 525; the second output y₂ of the layer may be the second output of the neural network, which was obtained in block 535; D_{W} may be a distance between the first output y₁ of the layer and the second output y₂ of the layer; t₁ may be a label of a first target T₁; and t₂ may be a label of a second target T₂.

Additionally, for example if the pairwise-constraint layer is a middle layer (i.e., a layer that is not an input layer or an output layer), then in equation (22) a first backpropagated value δ₁ may be based on the first output of the neural network, which was obtained in block 525, and on the one or more targets. Furthermore, a second backpropagated value δ₂ may be based on the second output of the neural network, which was obtained in block 535, and on the one or more targets. Moreover, the first output y₁ of the layer may be the first output of the pairwise-constraint layer, which was obtained in block 525; the second output y₂ of the layer may be the second output of the pairwise-constraint layer, which was obtained in block 535; and D_{W} may be a distance between the first output y₁ of the layer and the second output y₂ of the layer.

In block 550, the neural network is modified based on the gradient. For example, the weights of the pairwise-constraint layer of the neural network can be adjusted based on the gradient that was calculated in block 545, and the higher layers of the neural network can be adjusted based on the backpropagation of the gradient that was calculated in block 545. Thus, if the deepest layer is the pairwise-constraint layer, then adjustments that are based on the gradient of the joint loss function may be made throughout the entire neural network. Also, if a middle layer is the pairwise-constraint layer, then the adjustments that are based on the gradient of the joint loss function may be made through the higher layers of the neural network, but not the layers of the neural network that are deeper than the pairwise-constraint layer. Furthermore, in some embodiments, the backpropagation of the gradients is completed for the entire neural network before the network is modified. And, in some embodiments, the network is modified while the backpropagation is being performed.

Additionally, the operations of block 540 may modify two copies of a neural network. For example, the non-pairwise-constraint layers of one copy of the neural network may be modified according to backpropagation that is based on the first output and a first target, and the non-pairwise-constraint layers of the other copy of the neural network may be modified according to backpropagation that is based on the second output and a second target. After block 540 is finished, one of the two modified copies may be selected as the updated neural network.

Blocks 515-540 are repeated during an epoch. Depending on the embodiment, during the iterations of blocks 515-540 in an epoch, each possible pair combination of the samples is selected as the pair of samples in a respective iteration of block 515. Thus, if there are 4 samples, these embodiments would select 6 different pairs of samples in an epoch. However, not every embodiment uses each possible pair combination in an epoch.

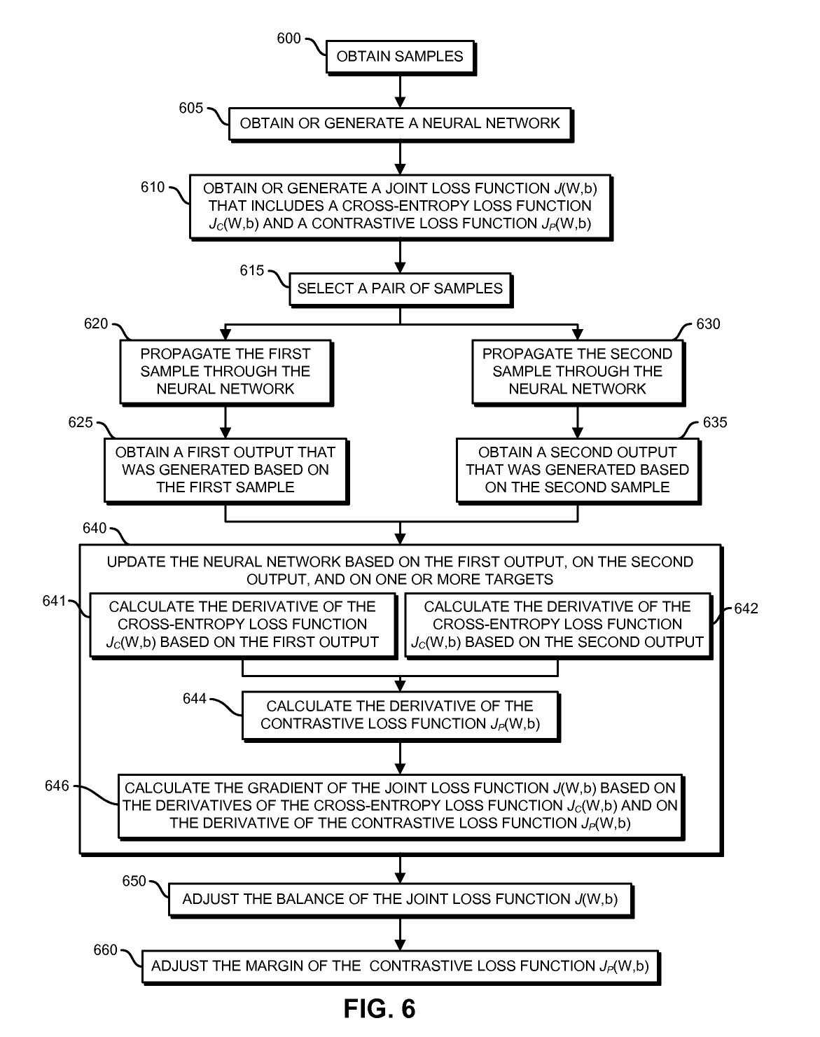

FIG. 6 illustrates an example embodiment of an operational flow for training a neural network with a joint loss function. The flow starts in block 600, where samples are obtained. In some embodiments, the samples are labeled. The flow then moves to block 605, where a neural network is obtained or generated. Next, in block 610, a joint loss function J(W,b) that includes a cross-entropy loss function J_{C}(W,b) and a contrastive loss function J_{P}(W,b) is generated or obtained. The flow then proceeds to block 615, where a pair of samples is selected.

The flow then splits into a first flow and a second flow. The first flow moves to block 620, where the first sample is forward propagated through the neural network. During block 620, a first output of the pairwise-constraint layer is generated. In block 625, a first output that was generated based on the first sample is obtained. The first output includes a first output of the neural network and the first output of the pairwise-constraint layer. In some embodiments, the first output of the neural network is the same as the first output of the pairwise-constraint layer, and in some embodiments, they are different. After block 625, the first flow proceeds to block 640.

Also, the second flow moves to block 630, where the second sample is forward propagated through the neural network. During block 630, a second output of the pairwise-constraint layer is generated. In block 635, a second output that was generated based on the second sample is obtained. The second output includes a second output of the neural network and the second output of the pairwise-constraint layer. In some embodiments, the second output of the neural network is the same as the second output of the pairwise-constraint layer, and in some embodiments, they are different. Then the second flow moves to block 640.

In block 640, the neural network is updated based on the first output, on the second output, and on one or more targets. The operations of block 640 include the operations of blocks 641, 642, 644, and 646, which are performed when the updating of the network reaches the layer of the neural network where the pairwise constraint is applied.

In block 641, the derivative of the cross-entropy loss function J_{C}(W,b) at the pairwise-constraint layer is calculated for the first sample based on the first output and on a first target. Depending on the embodiment, this derivative of the cross-entropy loss function J_{C}(W,b) may use the labels of the first sample as the first target or may use the first sample itself as the first target. Also, for example when the pairwise-constraint layer is a layer other than the output layer of the neural network, this derivative of the cross-entropy loss function J_{C}(W,b) at the pairwise-constraint layer may use backpropagated values of a derivative of the cross-entropy loss function J_{C}(W,b) that was calculated at the output layer based on the first output of the neural network and on the one or more targets. After block 641, the flow moves to block 644.

In block 642, the derivative of the cross-entropy loss function J_{C}(W,b) at the pairwise-constraint layer is calculated for the second sample based on the second output. Depending on the embodiment, this derivative of the cross-entropy loss function J_{C}(W,b) may use the labels of the second sample as the second target or may use the second sample itself as the second target. Additionally, this derivative of the cross-entropy loss function J_{C}(W,b) at the pairwise-constraint layer may use backpropagated values of a derivative of the cross-entropy loss function J_{C}(W,b) that was calculated at the output layer based on the second output of the neural network and on the one or more targets.

In block 644, the derivative of the contrastive loss function J_{P}(W,b) is calculated based on the first output of the pairwise-constraint layer and on the second output of the pairwise-constraint layer, for example according to

$$\frac{\partial {J}_{P} ( {D}_{W} )}{\partial {z}_{i}} = \frac{( {D}_{W} - m )}{{D}_{W}} \{ {( {y}_{1 i} - {y}_{2 i} )}^{2} - \sum ( {y}_{1 j} - {y}_{2 j} ) ( {y}_{1 j} {y}_{1 i} - {y}_{2 j} {y}_{2 i} ) \} ,$$

where m=mₛ for similar pairs, where m=m_{d} for dissimilar pairs, where y₁ᵢ is the i-th element of the first output y₁ of the pairwise-constraint layer, where y₁ⱼ is the j-th element of the first output y₁ of the pairwise-constraint layer, where y₂ᵢ is the i-th element of the second output y₂ of the pairwise-constraint layer, and where y₂ⱼ is the j-th element of the second output y₂ of the pairwise-constraint layer.

Next, in block 646, the gradient of the joint loss function J(W,b) is calculated based on the derivative of cross-entropy loss function J_{C}(W,b) for the first sample, on the derivative of cross-entropy loss function J_{C}(W,b) for the second sample, and on the derivative of the contrastive loss function J_{P}(W,b), for example according to equation (21) or equation (22). In block 640, the gradient of the joint loss function J(W,b) is backpropagated through the higher layers of the neural network. The neural network is then modified based on the gradient of the joint loss function.

After the neural network is updated in block 640, the flow then moves to block 650, where the balance of the joint loss function J(W,b) is adjusted by modifying one or both of the contributions α₁ and α₂. Finally, the flow proceeds to block 660, where the margin m of the contrastive loss function J_{P}(W,b) is adjusted. In embodiments where m=mₛ for similar pairs and where m=m_{d} for dissimilar pairs, one or both of mₛ and m_{d} can be adjusted.

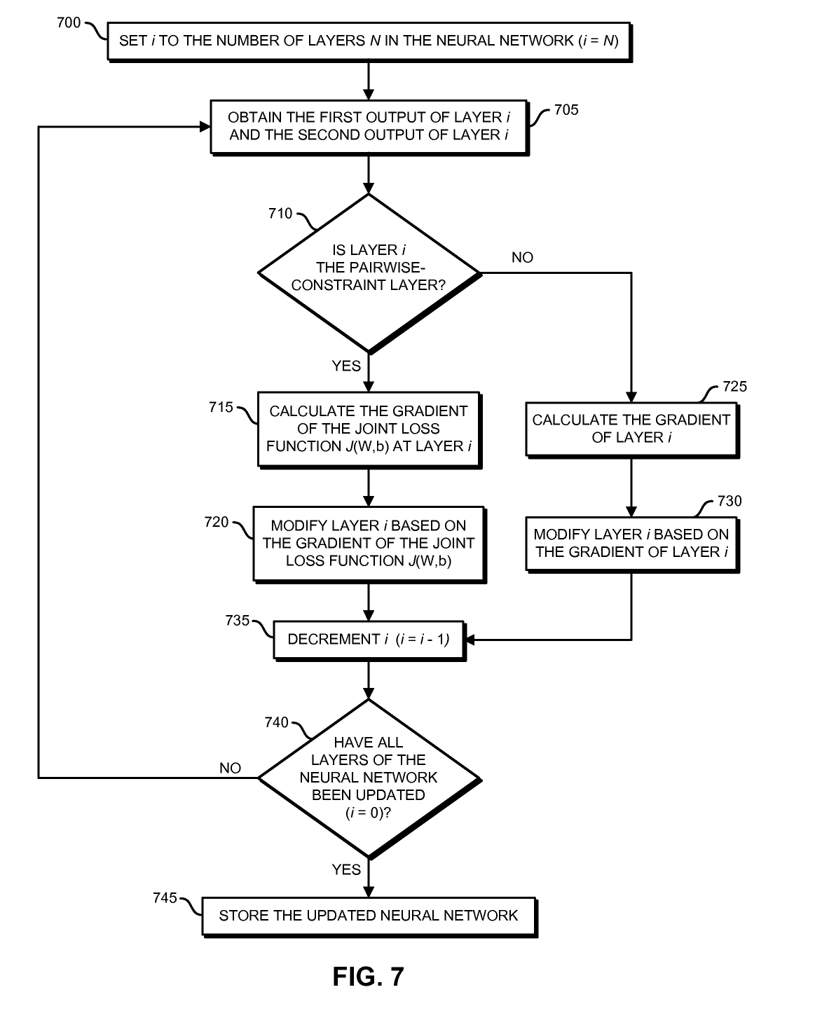

FIG. 7 illustrates an example embodiment of an operational flow for updating a neural network. In some embodiments, at least some of the operations of blocks 700-745 are performed while performing the operations of block 540 in FIG. 5 or the operations of block 640 in FIG. 6. The flow starts in block 700, where the count i is set to the number of layers N in the neural network (i=N). Furthermore, 1 is the index of the input layer, and N is the index of the output layer.

Next, in block 705, the first output of layer i and the second output of layer i are obtained. Also, one or more targets are obtained. The first output of layer i is the output of layer i that was generated during forward propagation of a first sample X₁ through the neural network, and the second output of layer i is the output of layer i that was generated during forward propagation of a second sample X₂ through the neural network.

For example, when i=N, the first output of layer i is the first output Y₁ of the neural network; the second output of layer i is the second output Y₂ of the neural network; and the one or more targets of layer i may be one or more of the first sample X₁, the second sample X₂, the labels of the first sample X₁, and the labels of the second sample X₂.

The flow then proceeds to block 710, where it is determined (e.g., by a system for training a neural network) whether layer i of the neural network is the pairwise-constraint layer. If yes (block 710=yes), then the flow moves to block 715. In block 715, the gradient of the joint loss function J(W,b) is calculated based on the first output of layer i and the second output of layer i, as well as on the one or more targets or any gradients of layers deeper than layer i that were previously calculated in block 725. Next, in block 720, layer i is modified based on the gradient of the joint loss function J(W,b). After block 720, the flow moves to block 735.

If in block 710 it is determined that layer i of the neural network is not the pairwise-constraint layer (block 710=no), then the flow moves to block 725. In block 725, if i=N, then the gradient of layer i is calculated based on the first output of layer i and the one or more targets of layer i, on the second output of layer i and the one or more targets of layer i, or both. However, if i<N, then the gradient of layer i is calculated based on one or more of the gradients of the layers deeper than layer i; these gradients were previously calculated in blocks 715 or 725. Next, in block 730, layer i is modified based on the gradient of layer i. Then the flow moves to block 735.

In block 735, the counter i is decremented. The flow then proceeds to block 740, where it is determined if all of the layers of the neural network have been updated (i=0). If not (block 740=no), then the flow returns to block 705. If yes (block 740=yes), then the flow moves to block 745, where the updated neural network is stored on one or more computer-readable media. Furthermore, in some embodiments, the operations of block 720 and 730 are not performed until after the gradients of all of the layers of the neural network have been calculated.

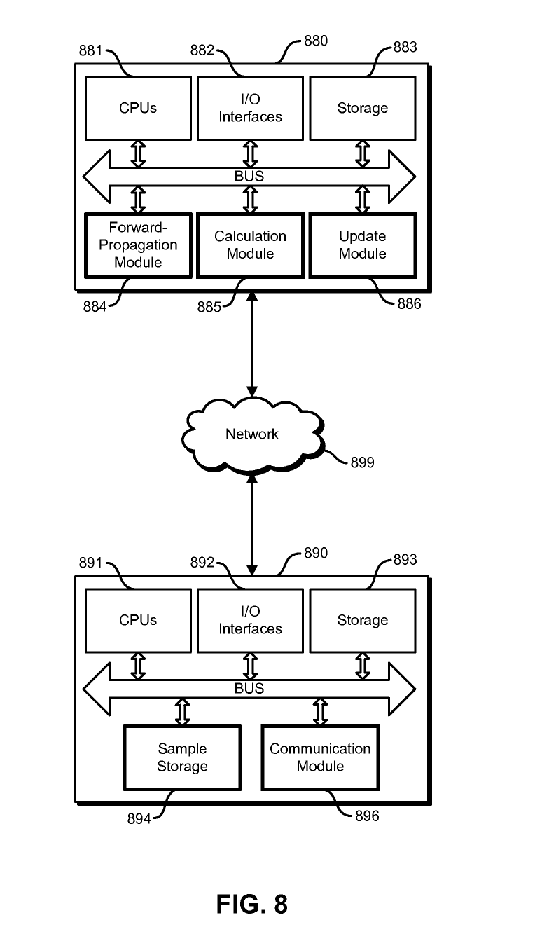

FIG. 8 illustrates an example embodiment of a system for training a neural network with a joint loss function. The system includes a model-generation device 880 and sample-storage device 890. In this embodiment, the devices communicate by means of one or more networks 899, which may include a wired network, a wireless network, a LAN, a WAN, a MAN, and PAN, etc. In some embodiments, the devices communicate by means of other wired or wireless channels.

The model-generation device 880 includes one or more processors (CPUs) 881, one or more I/O interfaces 882, and storage 883. Also, the components of the model-generation device 880 communicate by means of a bus. The CPUs 881 include one or more central processing units, which include microprocessors (e.g., a single core microprocessor, a multi-core microprocessor) or other circuits, and the CPUs 881 are configured to read and perform computer-executable instructions, such as instructions that are stored in storage, in memory, or in a module. The I/O interfaces 882 include communication interfaces to input and output devices, which may include a keyboard, a display, a mouse, a printing device, a touch screen, a light pen, an optical-storage device, a scanner, a microphone, a camera, a drive, a controller, and a network (either wired or wireless).

The storage 883 includes one or more computer-readable or computer-writable media, for example a computer-readable storage medium. As used herein, a transitory computer-readable medium refers to a mere transitory, propagating signal per se, and a non-transitory computer-readable medium refers to any computer-readable medium that is not merely a transitory, propagating signal per se. Also, a computer-readable storage medium, in contrast to a mere transitory, propagating signal per se, includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 883, which can include both ROM and RAM, can store computer-readable data or computer-executable instructions.

The model-generation device 880 also includes a forward-propagation module 884, a calculation module 885, and an update module 886. A module includes logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the devices in the system include additional or fewer modules, the modules are combined into fewer modules, or the modules are divided into more modules.

The forward-propagation module 884 includes instructions that, when executed, or circuits that, when activated, cause the model-generation device 880 to obtain one or more samples, for example from the sample-storage device 890; to obtain or generate a neural network; to select a pair of samples; and to forward propagate the pair of samples through the neural network to produce outputs. In some embodiments, this includes the operations of blocks 500 and 510-535 in FIG. 5 or the operations of blocks 600, 605, 615, 620, 625, 630, and 635 in FIG. 6. Also, the forward-propagation module 884 includes instructions that, when executed, or circuits that, when activated, cause the model-generation device 880 to obtain a query image and propagate the query image through the neural network, thereby producing representative features for the query image.

The calculation module 885 includes instructions that, when executed, or circuits that, when activated, cause the model-generation device 880 to obtain or generate a joint loss function; to calculate a gradient of the joint loss function, with a pairwise constraint, based on the outputs that were produced from a pair of respective inputs by the neural network; and to adjust the joint loss function. In some embodiments, this includes the operations of blocks 505 and 545 in FIG. 5 or includes the operations of blocks 610, 641, 642, 644, 646, 650, and 660 of FIG. 6.

The update module 886 includes instructions that, when executed, or circuits that, when activated, cause the model-generation device 880 to update the neural network based on a first output, on a second output, and on one or more targets. In some embodiments, this includes some of the operations in block 540 in FIG. 5, includes some of the operations of block 640 in FIG. 6, or includes some of the operations of blocks 700-745 in FIG. 7. Also, the update module 886 may call the calculation module 885.

The sample-storage device 890 includes one or more processors (CPUs) 891, one or more I/O interfaces 892, and storage 893, and the components of the sample-storage device 890 communicate by means of a bus. The sample-storage device 890 also includes sample storage 894 and a communication module 896. The sample storage 894 includes one or more computer-readable storage media that are configured to store samples. And the communication module 896 includes instructions that, when executed, or circuits that, when activated, cause the sample-storage device 890 to obtain samples and store them in the sample storage 894, to receive requests for samples (e.g., from the model-generation device 880), and to send samples from the sample storage 894 to other devices in response to received requests.

The above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board inserted into a device or on a function-extension unit connected to the device, and a CPU provided on the function-extension board or unit may implement at least some of the operations of the above-described embodiments.

Furthermore, some embodiments use one or more functional units to implement the above-described devices, systems, and methods. The functional units may be implemented in hardware alone (e.g., customized circuitry) or in a combination of software and hardware (e.g., a microprocessor that executes software).

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A method comprising:
obtaining a training set that includes digital images and side information of the digital images;
obtaining a joint loss function for two or more tasks; and
learning new features based on the joint loss function and on the training set of digital images.

2. The method of claim 1, wherein learning the new features comprises:
obtaining a neural network;
propagating a first sample from the training set through the neural network, thereby generating a first output of the neural network;
propagating a second sample from the training set through the neural network, thereby generating a second output of the neural network;
calculating a gradient of the joint loss function based on the first output of the neural network and on the second output of the neural network; and
modifying the neural network based on the gradient.

3. The method of claim 2, wherein the gradient of the joint loss function is calculated at an output layer of the neural network.

4. The method of claim 3, wherein calculating the gradient of the joint loss function based on the first output of the neural network and on the second output of the neural network includes
calculating a first gradient of the output layer of the neural network based on the first output of the neural network, on a first target, and on a cross-entropy loss function;
calculating a second gradient of the output layer of the neural network based on the second output of the neural network, on a second target, and on the cross-entropy loss function; and
calculating a third gradient of the output layer of the neural network based on the first output of the neural network, on the second output of the neural network, and on a contrastive loss function.

5. The method of claim 4, wherein the gradient
$$\frac{\partial J}{\partial {z}_{i}}$$
of the joint loss function is calculated according to
$$\frac{\partial J}{\partial {z}_{i}} = {α}_{1} ( {y}_{1 i} - {t}_{1 i} ) + {α}_{1} ( {y}_{2 i} - {t}_{2 i} ) + {α}_{2} \frac{( {D}_{W} - m )}{{D}_{W}} \{ {( {y}_{1 i} - {y}_{2 i} )}^{2} - {α}_{2} \sum ( {y}_{1 j} - {y}_{2 j} ) ( {y}_{1 j} {y}_{1 i} - {y}_{2 j} {y}_{2 i} ) \} ,$$
where α₁ controls a contribution of the cross-entropy loss function, where α₂ controls a contribution of the contrastive loss function, where y₁ᵢ and y₁ⱼ are elements of the first output y₁ of the neural network, where y₂ᵢ and y₂ⱼ are elements of the second output y₂ of the neural network, where t₁ᵢ is a component of the first target, where t₂ᵢ is a component of the second target, where D_{W} is a distance between the first sample and the second sample, and where m is a margin between similar pairs and dissimilar pairs.

6. The method of claim 5, wherein D_{W} is calculated according to
D_{W}(x₁,x₂)=∥y₁−y₂∥₂.

7. The method of claim 2, wherein the gradient of the joint loss function is calculated at a middle layer of the neural network.

8. The method of claim 7,
wherein propagating the first sample through the neural network generates a first output of the middle layer,
wherein propagating the second sample through the neural network generates a second output of the middle layer, and
wherein calculating the gradient of the joint loss function based on the first output and on the second output includes
calculating a first gradient of an output layer of the neural network based on the first output of the neural network, on a first target, and on a cross-entropy loss function;
backpropagating the first gradient of the output layer to the middle layer, thereby generating a first backpropagated gradient of the output layer;
calculating a gradient of the middle layer of the neural network based on the first output of the middle layer, on the second output of the middle layer, and on a contrastive loss function; and
calculating the gradient of the joint loss function based on the first backpropagated gradient of the output layer and on the gradient of the middle layer.

9. The method of claim 8, wherein calculating the gradient of the joint loss function based on the first output and on the second output further includes
calculating a second gradient of the output layer of the neural network based on the second output of the neural network, on a second target, and on the cross-entropy loss function;
backpropagating the second gradient of the output layer to the middle layer, thereby generating a second backpropagated gradient of the output layer; and
calculating the gradient of the joint loss function further based on the second backpropagated gradient of the output layer.

10. The method of claim 9, wherein the gradient
$$\frac{\partial J}{\partial {z}_{i}}$$
of the joint loss function is calculated according to
$$\frac{\partial J}{\partial {z}_{i}} = {α}_{1} ( {δ}_{1} ) + {α}_{1} ( {δ}_{2} ) + {α}_{2} \frac{( {D}_{W} - m )}{{D}_{W}} \{ {( {y}_{1 i} - {y}_{2 i} )}^{2} - {α}_{2} \sum ( {y}_{1 j} - {y}_{2 j} ) ( {y}_{1 j} {y}_{1 i} - {y}_{2 j} {y}_{2 i} ) \} ,$$
where α₁ controls a contribution of the cross-entropy loss function, where α₂ controls a contribution of the contrastive loss function, where δ₁ is the first backpropagated gradient of the output layer, where δ₂ is the second backpropagated gradient of the output layer, where y₁ᵢ and y₁ⱼ are elements of the first output y₁ of the middle layer, where y₂ᵢ and y₂ⱼ are elements of the second output y₂ of the middle layer, where D_{W} is a distance between the first sample and the second sample, and where m is a margin between similar pairs and dissimilar pairs.

11. The method of claim 2, wherein
the side information includes a binary or confidence based judgment about a similarity of a pair of images, or
the side information includes labels of the digital images.

12. A system comprising:
one or more computer-readable media; and
one or more processors that are coupled to the computer-readable media and that are configured to cause the system to
obtain a set of digital images;
obtain a neural network;
select a pair of digital images, which includes a first image and a second image;
forward propagate the first image through a first copy of the neural network, thereby generating a first output of the neural network;
forward propagate the second image through a second copy of the neural network, thereby generating a second output of the neural network;
calculate a gradient of a joint loss function at a pairwise-constraint layer of the neural network based on the first output of the neural network, on the second output of the neural network, and on a target; and
modify the neural network based on the gradient.

13. The method of claim 12, wherein
the joint loss function includes a cross-entropy loss function and a contrastive loss function, and
wherein, to calculate the gradient of the joint loss function, the one or more processors are further configured to cause the system to calculate a derivative of the cross-entropy loss function and calculate a derivative of the contrastive loss function.

14. The system of claim 13, wherein the one or more processors are configured to cause the system to calculate the derivative
$$\frac{\partial {J}_{C}}{\partial {z}_{i}}$$
of the cross-entropy loss Junction according to
$$\frac{\partial {J}_{C}}{\partial {z}_{i}} = {y}_{i} - {t}_{i} ,$$
where Σtⱼ=1, where yᵢ is an element of a first output of the pairwise-constraint layer, and where tᵢ is a component of the target.

15. The system of claim 13, wherein the one or more processors are configured to cause the system to calculate the derivative ∂J_{P}/∂zᵢ of the contrastive loss function according to
$$\frac{\partial {J}_{P} ( {D}_{W} )}{\partial {z}_{i}} = \frac{( {D}_{W} - m )}{{D}_{W}} \{ {( {y}_{1 i} - {y}_{2 i} )}^{2} - \sum ( {y}_{1 j} - {y}_{2 j} ) ( {y}_{1 j} {y}_{1 i} - {y}_{2 j} {y}_{2 i} ) \} ,$$
where m is a margin that defines a boundary between similar pairs and dissimilar pairs, where y₁ᵢ and y₁ⱼ are components of a first output of the pairwise-constraint layer, where y₂ᵢ and y₂ⱼ are components of a second output of the pairwise-constraint layer, and where D_{W}=∥y₁−y₂∥₂.

16. The system of claim 15, wherein the first output of the pairwise constraint layer is the first output of the neural network, and wherein the second output of the pairwise constraint layer is the second output of the neural network.

17. The system of claim 13, wherein the contrastive loss function includes a margin that defines a boundary between similar pairs and dissimilar pairs, and
wherein the one or more processors are configured to cause the system to adjust the margin.

18. The system of claim 13, wherein the one or more processors are further configured to cause the system to adjust a balance of the cross-entropy loss function and the contrastive loss function.

19. One or more computer-readable media storing instructions that, when executed by one or more computing devices, cause the one or more computing devices to perform operations comprising:
obtaining a set of digital images;
selecting a first pair of digital images, which includes a first image and a second image;
forward propagating the first image through a neural network, thereby generating a first output of the neural network;
forward propagating the second image through the neural network, thereby generating a second output of the neural network;
calculating a first gradient of a joint loss function based on the first output, on the second output, and on a first target; and
modifying the neural network based on the first gradient.

20. The one or more computer-readable media of claim 19, wherein the operations further comprise:
selecting a second pair of digital images, which includes a third image and a fourth image;
forward propagating the third image through the neural network, thereby generating a third output of the neural network;
forward propagating the fourth image through the neural network, thereby generating a fourth output of the neural network;
calculating a second gradient of the joint loss function based on the third output, on the fourth output, and on a second target; and
modifying the neural network based on the second gradient.

21. The one or more computer-readable media of claim 19, wherein calculating the first gradient of the joint loss function is further based on a second target.

22. The one or more computer-readable media of claim 19, wherein the joint loss function includes a contrastive loss function that applies a pairwise constraint to a layer of the neural network, and wherein calculating the first gradient of the joint loss function applies the pairwise constraint to the layer of the neural network.
